(19) United States
(12) Patent Application Publication
(10) Pub. No.: US 2024/0248595 A1
(43) Pub. Date: Jul. 25, 2024

(54) DATA ANALYSIS APPARATUS AND DATA ANALYSIS METHOD

(71) Applicant: SHIMADZU CORPORATION, Kyoto-shi, Kyoto (JP)

(72) Inventors: Ryuji SAWADA, Kyoto-shi, Kyoto (JP); Takeshi ONO, Kyoto-shi, Kyoto (JP); Shuhei YAMAMOTO, Kyoto-shi, Kyoto (JP); Hiroaki TSUSHIMA, Kyoto-shi, Kyoto (JP)

(73) Assignee: SHIMADZU CORPORATION, Kyoto-shi, Kyoto (JP)

(21) Appl. No.: 18/562,651

(22) PCT Filed: May 12, 2022
(86) PCT No.: PCT/JP2022/020077

§ 371 Date: Nov. 20, 2023

(30) Foreign Application Priority Data
Sep. 9, 2021 (JP) 2021-147149

(51) Int. Cl. G06F 3/04847; G06F 3/0481; G06V 10/94

(52) U.S. Cl. CPC G06F 3/04847; G06F 3/0481; G06V 10/945

(57) ABSTRACT

A data analysis apparatus (100) according to this invention includes a controller (10) configured to accept an operation of selection of an analysis data item(s) (500, 510, 520, 530), to accept an operation of selection of a script(s) to be used to analyze data based on the analysis data item(s) (500, 510, 520, 530), to accept an operation of adjustment of a parameter(s) to be used to execute the script(s), and to analyze the data by executing the script(s) based on the adjusted parameter(s).

### TECHNICAL FIELD

The present invention relates to a data analysis apparatus and a data analysis method.

### BACKGROUND ART

Apparatuses configured to execute predetermined control by using a script, which is a program executed by a computer, are known in the art. Such an apparatus is disclosed in Japanese Patent Laid-Open Publication No. JP H06-124012, for example.

Japanese Patent Laid-Open Publication No. JP H06-124012 discloses an image-forming apparatus configured to execute diagnostic checks on itself based on simulation results of an external apparatus. When detecting a fault, the image-forming apparatus reads repair operations for repairing the fault (predetermined control) from a work script table that stores a plurality of work scripts (programs executed by a computer). Operation amounts (increase or decrease amount) of parameters such as halogen light amount are previously specified in the operation scripts.

### PRIOR ART

### Patent Document

Patent Document 1: Japanese Patent Laid-Open Publication No. JP H06-124012

### SUMMARY OF THE INVENTION

### Problems to be Solved by the Invention

In the image-forming apparatus in Japanese Patent Laid-Open Publication No. JP H06-124012, processes are executed based on values of parameters, which are previously specified in the work scripts (program executed by the computer). In this case, every when the values of parameters are required to be changed according to applications or purposes, users necessarily create a new script corresponding to the new parameters. Such work of creating the new script imposes a large burden on the users.

The present invention is intended to solve the above problem, and one object of the present invention is to provide a data analysis apparatus and a data analysis method capable of reducing a burden on users in a case in which values of parameters are changed and work scripts corresponding to the changed value are executed.

### Means for Solving the Problems

In order to attain the aforementioned object, a data analysis apparatus according to a first aspect of the present invention includes a controller configured to accept an operation of selection of an analysis data item(s) acquired by an analyzer, to accept an operation of selection of a script(s) to be used to analyze data based on the analysis data item(s), to accept an operation of adjustment of a parameter(s) to be used to execute the script(s), and to analyze the data by executing the script(s) based on the adjusted parameter(s); and a display configured to display an analysis result obtained by the analysis of the data by the controller. The script refers to a simple program configured to be able to be executed by a computer.

Also, a data analysis method according to a second aspect of the present invention includes a step of accepting selection of an analysis data item(s) acquired by an analyzer; a step of accepting selection of a script(s) to be used to analyze data based on the analysis data item(s); a step of accepting adjustment of a parameter(s) to be used to execute the script(s); and a step of analyzing the data by executing the script(s) based on the adjusted parameter(s).

### Effect of the Invention

In the data analysis apparatus according to the aforementioned first aspect of this invention, as discussed above, the controller is configured to accept an operation of adjustment of a parameter(s) to be used to execute the script(s). Accordingly, because a parameter(s) in an existing script(s) can be adjusted and the script(s) can be then executed, the script can be executed by using value(s) of the parameter(s) depending on applications or purposes. As a result, even when the value(s) of parameter(s) is/are required to be changed, work of creating a new script (program executed by a computer) corresponding to such new parameter(s) can be omitted. A burden on a user in the work of adjusting parameters in such an existing script is smaller than the work of entirely creating a new script from scratch. Consequently, the controller can reduce the burden on a user in the work by accepting an operation of adjustment of a parameter(s) to be used to execute the script(s). The same effect can be obtained by the data analysis method according to the second aspect including the step of accepting adjustment of a parameter(s) to be used to execute the script (s).

### BRIEF DESCRIPTION OF THE DRAWINGS

FIG. 1 is a diagram showing a configuration of an image analysis apparatus according to an embodiment.

FIG. 2 is a view showing a registration screen of the image analysis apparatus according to the embodiment.

FIG. 3 is a view showing a dataset generation screen of the image analysis apparatus according to the embodiment with data being displayed before a script is executed.

FIG. 4 is a view showing a parameter adjustment screen of the image analysis apparatus according to the embodiment.

FIG. 5 is a view showing the parameter adjustment screen of the image analysis apparatus according to the embodiment with text of explanation for a parameter being displayed.

FIG. 6 is a view showing the dataset generation screen of the image analysis apparatus according to the embodiment with data being displayed after the script is executed.

FIG. 7 is a view showing an analysis recipe generation screen of the image analysis apparatus according to the embodiment.

FIG. 8 is a flowchart illustrating registration of a script and a parameter definition files in the image analysis apparatus according to the embodiment.

FIG. 9 is a flowchart illustrating adjustment of parameters and execution of a script in the image analysis apparatus according to the embodiment.

FIG. 10 is a view showing an analysis recipe in an image analysis apparatus according to a modified embodiment.

### MODES FOR CARRYING OUT THE INVENTION

Embodiments embodying the present invention will be described with reference to the drawings.

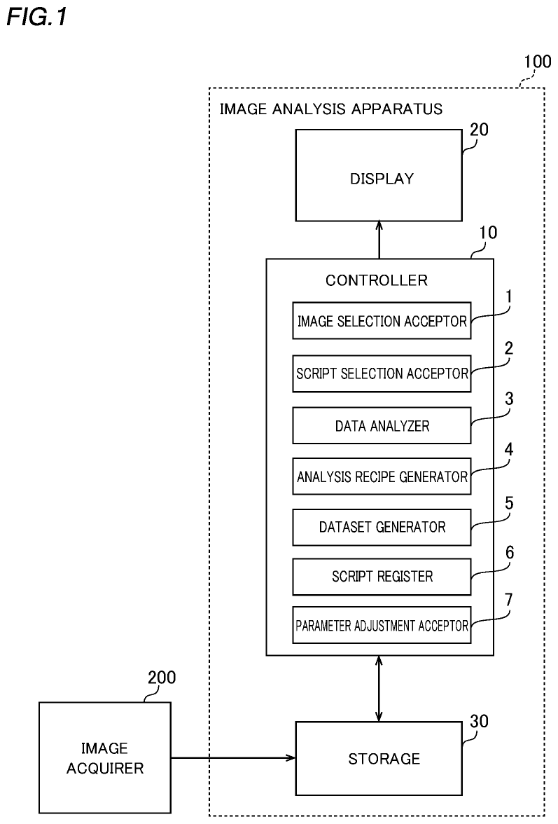

A configuration of an image analysis apparatus 100 according to an embodiment is now entirely described with reference to FIGS. 1 to 9. The image analysis apparatus 100 is an example of a “data analysis apparatus” in the of claims.

### (Configuration of Image Analysis Apparatus)

The image analysis apparatus 100 includes a controller 10 and a display 20. In addition, the image analysis apparatus 100 includes a storage 30 configured to store image data, etc. acquired by an external image acquirer 200. The storage 30 is constructed of a hard disk or flash memory, for example. The display 20 is configured to an analysis result obtained by analysis of data by the controller 10. The image data acquired by the image acquirer 200 may be stored in an external device of the image analysis apparatus 100, or in a storage area (for example, a cache memory) of the image analysis apparatus 100 different from the storage 30. In addition, the image analysis apparatus 100 itself may have a mechanism for acquiring image data for analysis. The image acquirer 200 is an example of an “analyzer” in the claims. The image data acquired by the image acquirer 200 is an example of “analysis data” and “data based on the analysis data” in the claims.

The controller 10 serves as an image selection acceptor 1, a script selection acceptor 2, a data analyzer 3, an analysis recipe generator 4, a dataset generator 5, a script register 6, and a parameter adjustment acceptor 7. The controller 10 can serve as an image selection acceptor 1, a script selection acceptor 2, a data analyzer 3, an analysis recipe generator 4, a dataset generator 5, a script register 6, and a parameter adjustment acceptor 7 by executing software such as programs.

The image selection acceptor 1 (controller 10) is configured to accept an operation of selection of an image data item acquired by the image acquirer 200. The script selection acceptor 2 (controller 10) is configured to accept an operation of selection of a script to be used to analyze data based on the image data acquired by the image acquirer 200. The parameter adjustment acceptor 7 (controller 10) is configured to accept an operation of adjustment of parameters to be used to execute the script. These control functions will be described later.

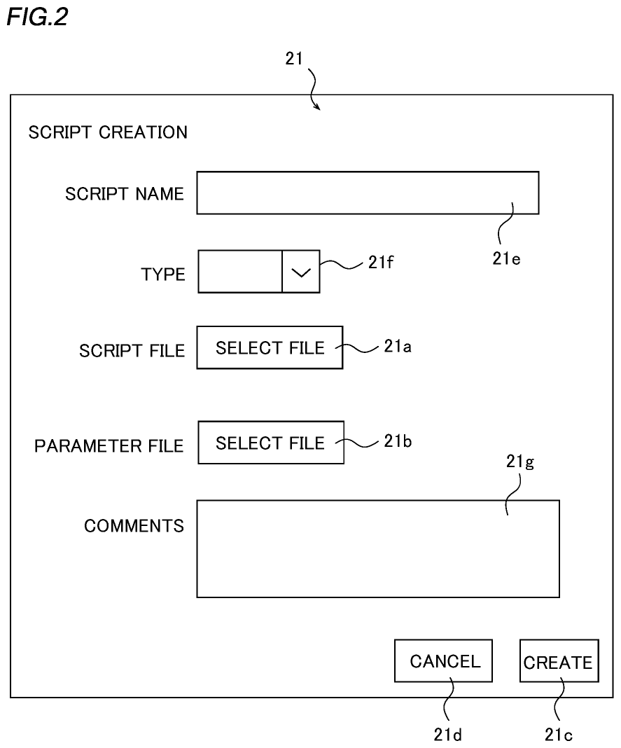

As shown in FIG. 2, the controller 10 is configured to make the display 20 to display a registration screen 21 for previously registering the scripts and a parameter definition file that defines parameter adjustment information relating to adjustment of the parameters. When a button 21a indicating “Select File” on the registration screen 21 is selected, a script to be registered can be selected. When a button 21b indicating “Select File” on the registration screen 21 is selected, a parameter definition file to be registered can be selected.

In this embodiment, the script register 6 (controller 10) is configured to store correlate the script and the parameter definition file, which are registered in the registration screen 21, with each other and to store the script and the parameter definition file, which are correlated with each other. Accordingly, when the script is executed, processing is executed based on parameters that are defined in the parameter definition file correlated with the script. Specifically, after one script and one parameter definition file are selected by operations of pressing the button 21a and the button 21b, when a button 21c indicating “Create” on the registration screen 21 is pressed, the selected script and the selected parameter definition file are correlated with each other and saved (registered) in the storage 30. If a button 21d indicating “Cancel” on the registration screen 21 is pressed, the registration screen 21 is closed.

The registration screen 21 includes a text box 21e into which a user can enter a name of the script to be registered, a selector 21f that allows the user to select a type of script, and a text box 21g into which the user can enter a comment. It is conceived that the user writes a description of the parameters, etc., in the text box 21g.

For example, the type can be selected from types (kinds) including a label processing type relating to generation of label images used for machine learning, a preprocessing type relating to preprocessing (e.g., adjustment of contrast) applied to images used for machine learning, and an analysis type relating to analysis of data, etc.

In this embodiment, the parameter definition file includes information on initial values of the parameters, adjustable ranges of the parameters, and types of the parameters The types of the parameter include information on whether the parameter is an integer, and a bool value (True or False). In addition, the parameter definition file includes the description of the parameters.

In this embodiment, the controller 10 is configured to determine whether a format of the parameter definition file is correct when registering the parameter definition file. Specifically, the controller 10 determines whether the registered parameter definition file has a predetermined format (for example, Jason format). The controller 10 provides an error when determining that the registered parameter definition file does not have the specified format. For example, the controller 10 displays a warning or generates an audible alarm whereby providing an error.

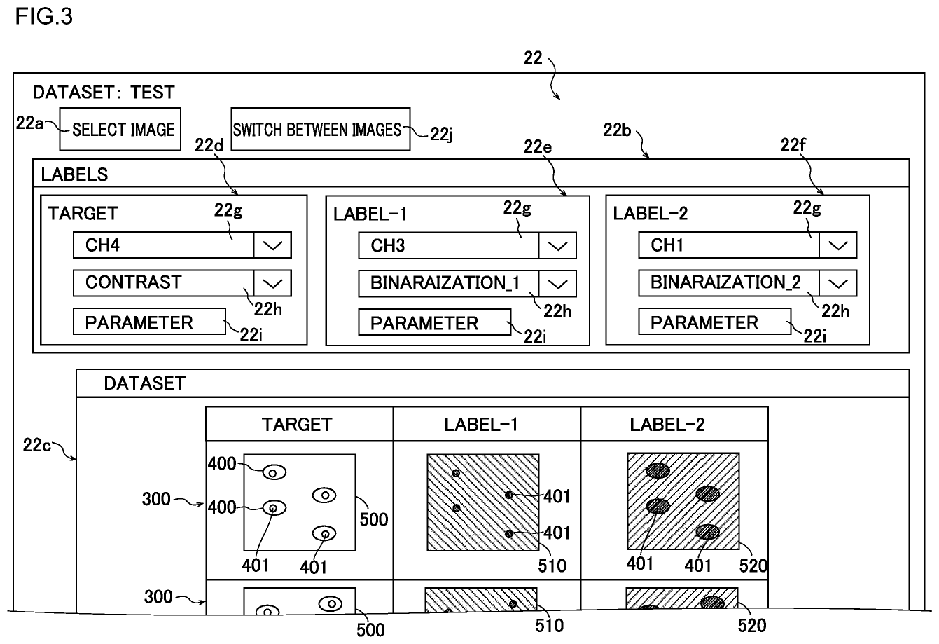

Control of accepting selection of an analysis data item, control of accepting selection of a script, and control of adjustment of parameters to be used to execute the script executed by the controller 10 are now described with reference to FIGS. 3 to 6.

FIG. 3 is a view illustrating a dataset generation screen 22 displayed on the display 20 when datasets 300 each of which includes machine learning data items are generated. The dataset generation screen 22 is displayed on the display 20 in accordance with an operation provided by a user on a home screen (not shown), for example. The dataset generator 5 (controller 10) is configured to generate the datasets 300 based on an operation of selection of a data item, a script, etc. on the dataset generation screen 22. The dataset generation screen 22 is an example of a “screen for accepting an operation that is provided by the user to instruct to display the parameter adjustment screen” in the claims.

When a button 22a indicating “Select Image” on the dataset generation screen 22, image data to be used to generate machine learning data becomes selectable. Also, a field 22b indicating “Labels” and a field 22c indicating “Dataset” are displayed on the dataset generation screen 22. The field 22b includes a field 22d indicating “TARGET”, a field 22e indicating “LABEL-1”, and a field 22f indicating “LABEL-2”. Each of the fields 22d to 22f includes a selector 22g configured to be able to select an image type by pressing ‘ch’. The “selector” in this embodiment is a pull-down list configured to realize the selection.

For example, when “ch4” is pressed in the selector 22h in the field 22d indicating “TARGET” shown in FIG. 3, one or more phase contrast images 500 corresponding to the selected image data are selected by an operation of pressing the button 22a. Also, when “ch3” is pressed in the selector 22g in the field 22e indicating “LABEL-1” shown in FIG. 3, one or more fluorescence images 510 corresponding to the selected phase contrast images 500. Also, when “ch1” is pressed in the selector 22g in the field 22f indicating “LABEL-2” shown in FIG. 3, one or more fluorescence images 520 corresponding to the selected phase contrast images 500. For example, the fluorescence image 510 of “LABEL-1” is an image for clearly showing nucleus 401 of cells 400, and the fluorescence image 520 of “LABEL-2” is an image clearly showing cell areas included in the cells 400 (skeletons of cells 400). In response to the aforementioned operations, one or more datasets 300 each of which includes three image data items of “TARGET”, “LABEL-1”, and “LABEL-2” are displayed in the field 22c indicating “Dataset”. If a plurality of datasets 300 are displayed, the datasets are aligned in a vertical direction in the field 22c. In the exemplary screen shown in FIG. 3, a first dataset 300 and a part of a second dataset 300 are illustrated. The phase contrast image 500, the fluorescence image 510, and the fluorescence image 520 are examples of an “analysis data”, a “data based on the analysis data”, and a “data before the script is applied” in the claims.

In addition, each of the fields 22d to 22f includes a selector 22h configured to select a machine learning data generation algorithm for generating the machine learning data to be used for machine learning. The script selection acceptor 2 (the controller 10) is configured to accept selection of a machine learning generation algorithm in the selector 22h. The machine learning generation algorithm is an example of the “script” in the claims.

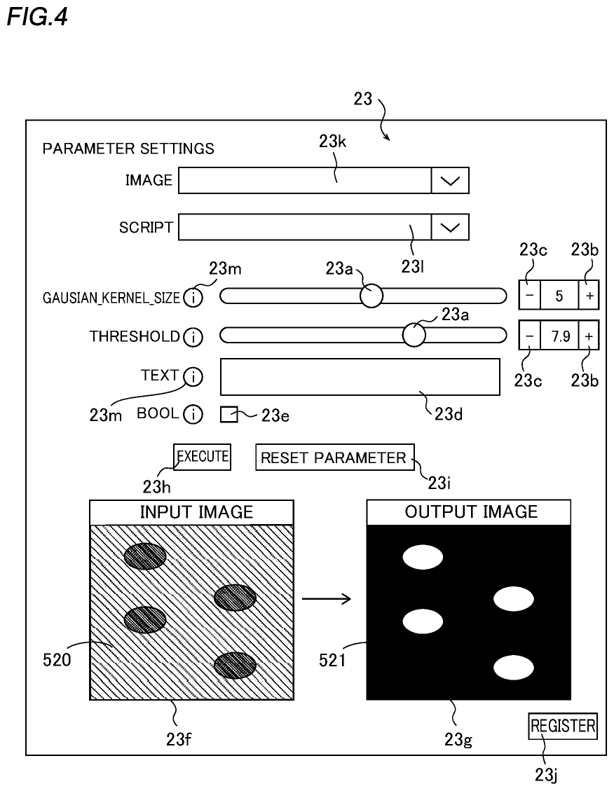

The controller 10 also is configured to make the display 20 to display a parameter adjustment screen 23 (see FIG. 4) in accordance with an operation provided by the user. Specifically, each of the fields 22d to 22f includes a button 22i indicating “Parameter”. When the button 22i indicating “Parameters” is pressed by the user in any of the fields 22d to 22f, the parameter adjustment screen 23 for adjusting a parameter of the machine learning data generation algorithm that is selected in the selector 22h is displayed on the display 20.

In an exemplary screen shown in FIG. 4, the parameter adjustment screen 23 corresponding to “binaraization_2”, which is an algorithm for binary processing, is illustrated. Although components other than components of the adjustment screen 23 are omitted in FIG. 4, for ease of illustration, the adjustment screen 23 is superposed on the dataset generation screen 22 displayed on the display 20.

In this embodiment, the parameter adjustment acceptor 7 (controller 10) is configured to accept an operation of adjustment of one or more parameters on the parameter adjustment screen 23 as shown in in FIG. 4. Specifically, the parameter adjustment screen 23 displays parameters defined in the parameter definition file that is correlated with the script when stored.

In this embodiment, the parameter adjustment acceptor 7 (controller 10) is configured to accept an operation of adjustment of a plurality of parameters on the common adjustment screen 23. If a plurality of parameters are defined in the parameter definition file that is correlated with the script and when stored, the plurality of parameters are displayed on the same adjustment screen 23. In the exemplary screen shown in FIG. 4, two parameters whose parameter values are variable are displayed on the adjustment screen 23. Specifically, in the exemplary screen shown in FIG. 4, values of Gaussian kernel size (size of area used in the Gaussian function) and threshold (threshold of the binarization) can be changed. The parameter definition file includes definition that defines the parameter value as variables to be adjusted by an integer or a decimal fraction. The Gausian_kernel_size can be illustratively adjusted by an integer, while the threshold can be illustratively adjusted by a decimal fraction in FIG. 4. The parameter values can be changed (increased/decreased) by moving buttons 23a in a leftward/rightward direction on the parameter adjustment screen 23 or by clicking a button 23b indicating “+” (button 23c indicating with “−”)

In the exemplary screen shown in FIG. 4, a text box 23d into which the user can enter text is displayed on the parameter adjustment screen 23. The parameter adjustment acceptor 7 (controller 10) is configured to allow the user to enter text into the text box 23d. The text entered in the text box 23d will be displayed in an analysis result obtained by executing the script, for example. In other words, the text displayed in the analysis result can be specified (adjusted) in the parameter adjustment screen 23.

In the exemplary screen shown in FIG. 4, a check box 23e is displayed on the parameter adjustment screen 23. The parameter adjustment acceptor 7 (controller 10) is configured to allow the user to check (uncheck) the check box 23e. If the check box 23e is checked, the script corresponding to the parameter adjustment screen 23 is not executed.

In this embodiment, the controller 10 is configured to display, on the parameter adjustment screen 23, the data before the script is applied (data displayed in a field 23f indicating “Input Image” in FIG. 4), and test output data that is obtained by applying to the data the script whose parameters are adjusted on a test basis (data displayed in a field 23g indicating “output image” in FIG. 4) side by side. In the exemplary screen shown in FIG. 4, when a button 23h indicating “Execute” on the registration screen 21 is pressed after the parameters are adjusted in accordance with the aforementioned operations, the binary image 521 corresponding to the fluorescence image 520 will be displayed in the field 23g arranged on the right side of the field 23f in which the fluorescence image 520 is displayed.

The parameter adjustment acceptor 7 (controller 10) is configured to reset the adjusted parameters to initial values when a button 23i indicating “Reset Parameter” is pressed on the parameter adjustment screen 23.

The parameter adjustment acceptor 7 (controller 10) is configured to correlate the adjusted parameters, the script whose parameters are adjusted, and the dataset 300 corresponding to the script whose parameters are adjusted with each other and to save (register) them in the storage 30 when a button 23j indicating “Register” is pressed on the parameter adjustment screen 23.

Also, the image selection acceptor 1 (controller 10) is configured to accept selection of an image data item to be displayed in the field 23f of the parameter adjustment screen 23 (i.e., an image data item to which the script is applied on a test basis) in a selector 23k of the parameter adjustment screen 23.

In this embodiment, the script selection acceptor 2 (controller 10) is configured to accept an operation of selection of the script on the adjustment screen 23. Specifically, the script selection acceptor 2 (controller 10) is configured to accept the operation of selection (change) of the script to be executed in the selector 231. If the script to be executed is selected (changed) in the selector 231, the parameters corresponding to the selected (changed) script are displayed on the adjustment screen 23.

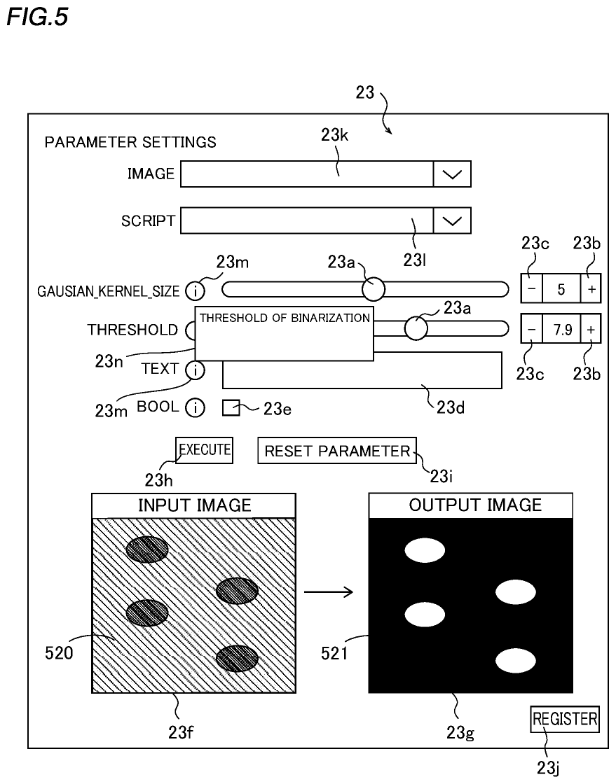

In the exemplary screen shown in FIG. 4, buttons 23m are displayed on the right sides of parameter names in the parameter adjustment screen 23. The controller 10 is configured to display, when one of the button 23m is pressed, text 23n (see FIG. 5) indicating description of the parameter corresponding to one of the buttons 23m on the parameter adjustment screen 23.

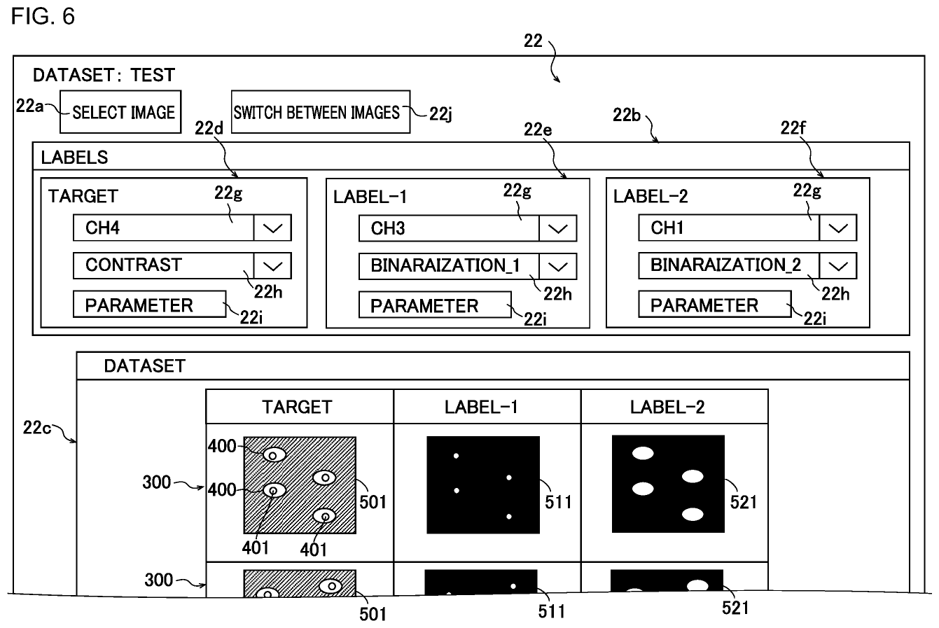

In this embodiment, the controller 10 is configured to selectively display, on the dataset generation screen 22, the data before the script is applied, and test output data that is obtained by applying to the data the script whose parameters are adjusted on a test basis in accordance with an operation provided by the user. Specifically, when a button 22j (see FIG. 3) indicating “Switch between Images” is pressed on the dataset generation screen 22, all the data items displayed in the field 22c of dataset are switched between the data items before the script is applied (see FIG. 3) and the data items after the script is applied (see FIG. 6).

When “contrast”, which is a machine learning data generation algorithm for contrast adjustment, is selected in the selector 22h of the field 22d indicating “TARGET” in the field 22b of “Labels” is selected, a contrast adjustment image 501, which is generated by applying the contrast adjustment machine learning data generation algorithm for contrast adjustment to the phase contrast image 500 (see FIG. 3), is displayed in the field 22c of “Dataset” as shown in FIG. 6. When “binaraization_1”, which is a machine learning data generation algorithm for binarization, is selected in the selector 22e of the field 22d indicating “Label-1” in the field 22b of “Labels” is selected, a binary image 511 corresponding to a fluorescence image 510 (see FIG. 3) is displayed in the field 22c of “Dataset”. When “binaraization_2”, which is a machine learning data generation algorithm for binarization, is selected in the selector 22h of the field 22f indicating “Label-2” in the field 22b of “Labels” is selected, a binary image 521 corresponding to a fluorescence image 520 (see FIG. 3) is displayed in the field 22c of “Dataset”. The contrast adjustment image 501, the binary image 511, and the binary image 521 are examples of the “data based on the analysis data”, an “analysis result”, “test output data”, and “machine learning data”.

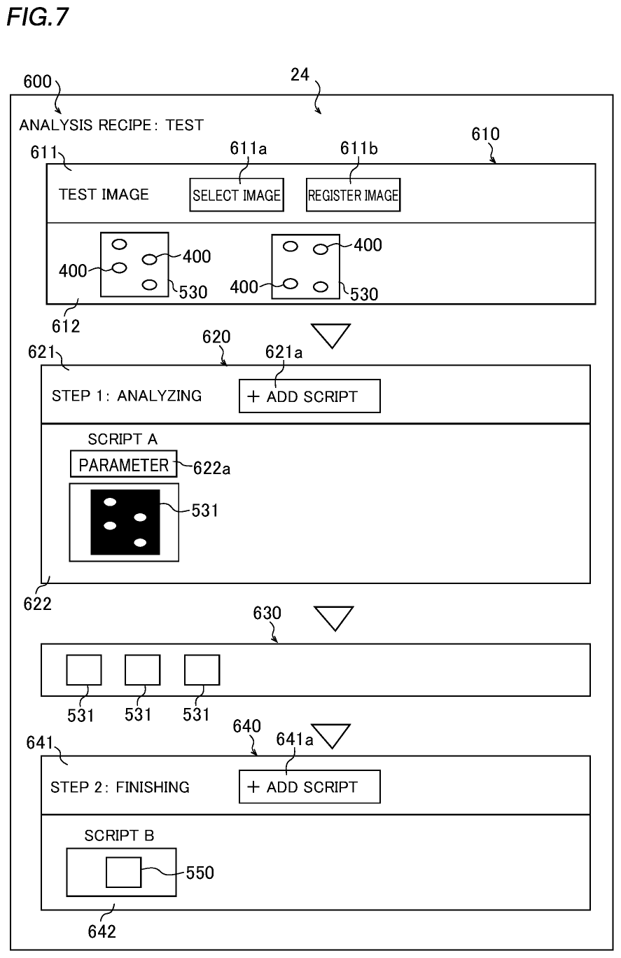

FIG. 7 is a view illustrating an analysis recipe generation screen 24 displayed on the display 20 when an analysis recipe 600 is generated by combining a plurality of analysis algorithms. The analysis recipe generation screen 24 is displayed on the display 20 in accordance with an operation provided by the user on a home screen (not shown), for example. The analysis recipe generator 4 (controller 10) is configured to generate the analysis recipe 600 based on an operation of selection of a data item, a script, etc. on the analysis recipe generation screen 24. The analysis recipe 600 and the analysis recipe generation screen 24 are examples of an “analysis flow” and an “analysis flow generation screen” in the claims, respectively. Also, the analysis algorithm is an example of the “script” in the claims. Also, the analysis recipe generation screen 24 is an example of a “screen for accepting an operation that is provided by the user to instruct to display the parameter adjustment screen” in the claims.

The analysis recipe 600 includes an analysis step (Step 1) of analysis using a learned models and an analysis algorithms, and a finishing step (Step 2) of finishing processing. The finishing processing includes a process of bringing a plurality of analysis results provided in the analysis together, and a process of analyzing variations between the plurality of analysis results. The following description describes a specific method of generating the analysis recipe 600.

The image selection acceptor 1 (controller 10) accepts an operation of selection of an image data item 530 to be analyzed. Specifically, as shown in FIG. 7, when a button 611a indicating “Select Image” in an upper field 611 in a field 610 of “Test Image” is pressed in the analysis recipe generation screen 24, a window that allows a user to select the image data item 530 to be analyzed from a plurality of image data items stored in the storage 30 is displayed. Also, when a button 611b indicating “Register Image” in the upper field 611 is pressed, a window that allows the user to select (resister) an image data item that is not saved in the storage 30 (for example, stored in a local PC) as the image data item 530 to be analyzed is displayed. The image data 530 selection of which is accepted is displayed in a lower field 612 of “Test Image”. In the exemplary screen shown in FIG. 7, the image data item 530 including cells 400 is displayed in the lower field 612. The image data item 530 is an example of the “analysis data”, the “data based on the analysis data”, and the “data before the script is applied” in the claims.

When the button 611b indicating “Register Image” is pressed and the selection of the image data item 530 is accepted, the input of associated information with image data item 530 is accepted. The selected image data 530 and the associated information accepted as the input are associated with each other, and are stored (registered) in the storage 30. Registration of image data of a cell culture is described as exemplary registration of image data 530. In this case, for example, it can be conceived that users are allowed to enter the number of passages of cells (operations of removing a medium from the culture system and transferring the cells to anew medium), and the number of culture days.

The controller 10 is configured to group a plurality of image data items 530 in according to conditions based on the aforementioned associated information. For example, the controller 10 can classify the plurality of image data items 530 into groups of cells each of which corresponds to the same passage number, groups of cells each of which corresponds the same number of culture days, corresponds both the same passage number and the same number of culture days, etc.

The script selection acceptor 2 (controller 10) is configured to accept selection of a script to be used to analyze data based on the selected image data items 530. For example, when a button 621a indicating “+Add Script” in the upper field 621 of a field 620 of “Analysis Processing” is pressed in the analysis recipe generation screen 24, a window that allows the user to select the script to be executed from a plurality of scripts stored in the storage 30 is displayed. In this selection, the script to be executed can be selected from the learned models and analysis algorithms registered in the storage 30. The data analyzer 3 (controller 10) is configured to analyze the image data items 530 by using the selected script.

Subsequently, analysis results of the selected script (data 531) are displayed in a lower field 622 of “Analysis processing”. In the exemplary screen shown in FIG. 7, a binarization script A is applied to the image data items 530 to be analyzed. The data items 531 are examples of the “data based on the analysis data”, the “analysis data”, and the “test output data” in the claims. The script A is an example of an “analysis algorithm” in the claims.

When a button 622a indicating “Parameter” arranged in the lower field 622 of the “Analysis Processing” field 620 is pressed, the parameter adjustment screen 23 of the executed script is displayed. Because functions of the adjustment screen 23 displayed in this case are similar to the adjustment screen 23 shown in FIG. 4, the functions are denoted by the same reference numerals, and their description is omitted. After the parameters are adjusted in the adjustment screen 23 displayed in this case, the data items 531 displayed on the analysis recipe generation screen 24 change according to the parameter adjustment. In addition, when the parameters are registered in the adjustment screen 23 displayed in this case, the adjusted parameter, the script corresponding to the adjusted parameters, and the analysis recipe 600 corresponding script corresponding to the adjusted parameters are correlated with each other and are saved (registered) in the storage 30.

Each of the plurality of scripts includes information whether the analysis result (output data) is to be subject to finishing processing. In the analysis results of the scripts in the analysis processing, the data item 531 that is to be subject to finishing processing is temporarily saved (buffered) as the items to be subject to finishing processing and is displayed in the field 630. The data items 531 are examples of the “data based on the analysis data” in the claims. The data items 531 are simply shown as a blank image for ease of illustration.

The controller 10 is configured to bring a plurality of buffered data items 540 together by using a script B (apply finishing to the buffered data items). After that, the data items 550 are displayed in the lower field 642. When a button 641a indicating “+Add Script” in the upper field 641 in a field 640 of “Finishing” is pressed, scripts for other finishing processing stored in the storage 30 can be selected. The data item 550 is simply shown as a blank image for ease of illustration. The script B is an example of the “analysis algorithm” in the claims.

### (Control Flow in Script Registration)

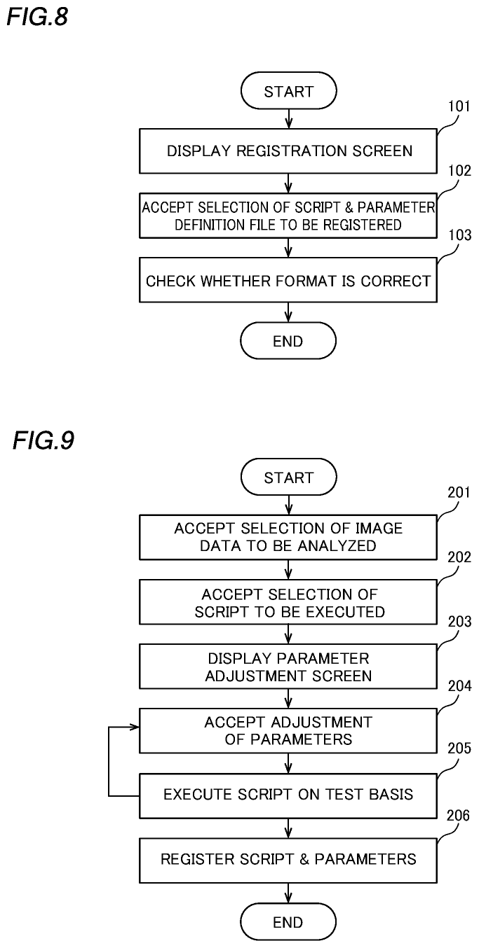

A control flow of the controller 10 in script registration is now described with reference to FIG. 8.

As shown in FIG. 8, the registration screen 21 is first displayed in step 101. For example, the controller 10 make the display 20 to display the registration screen 21 in accordance with an operation provided by a user on a home screen (not shown).

Subsequently, in step 102, the controller 10 accepts selection of a script and a parameter definition file to be registered. Specifically, the script selection acceptor 2 (controller 10) accepts selection of the script to be registered based on selection of the button 21a (see FIG. 2) on the registration screen 21. Also, the controller 10 accepts selection of the parameter definition file to be registered based on selection of the button 21b (see FIG. 2) on the registration screen 21.

In step 103, the controller 10 determines whether a format of the parameter definition file registered in step 102 is correct. As described above, the controller 10 determines whether the format of the registered parameter definition file is a predetermined format (for example, Jason format).

(Control Flow in Parameter Adjustment and Script Execution) A control flow of the controller 10 in parameter adjustment and execution of analysis using the script is now described with reference to FIG. 9.

In step 201, selection of image data to be analyzed is first accepted. Specifically, the image selection acceptor 1 (controller 10) accepts selection of the image data items (500, 510, 520) to be analyzed based on selection of the button 22a and selection of the selectors 22g on the dataset generation screen 22 (see FIG. 3). Also, the image selection acceptor 1 (controller 10) accepts selection of the image data items (530) to be analyzed based on the selection of the buttons 611a and 611b on the analysis recipe generation screen 24 (see FIG. 7). Also, the image selection acceptor 1 (controller 10) accepts selection of the image data items (500, 510, 520, 530) to be analyzed based on selection of the selector 23k on the parameter adjustment screen 23 (see FIG. 4).

Subsequently, in step 202, selection of the script to be executed is accepted. Specifically, the script selection acceptor 2 (controller 10) accepts selection of the script to be executed based on selection of the selector 22h on the dataset generation screen 22 (see FIG. 3). Also, the script selection acceptor 2 (controller 10) accepts selection of the script to be executed based on selection of the button 621a and the button 641a on the analysis recipe generation screen 24 (see FIG. 7). Also, the script selection acceptor 2 (controller 10) accepts selection (change) of the script to be executed based on selection of the selector 231 on the parameter adjustment screen 23 (see FIG. 4).

Subsequently, in step 203, the parameter adjustment screen 23 is displayed. Specifically, the parameter adjustment screen 23 is displayed on the display 20 based on selection of the button 22i on the dataset generation screen 22 (see FIG. 3). Also, the parameter adjustment screen 23 is displayed on the display 20 based on selection of the button 622a on the analysis recipe generation screen 24 (see FIG. 7).

Subsequently, in step 204, the parameter adjustment acceptor 7 (controller 10) accepts an operation of adjusting parameters on the parameter adjustment screen 23 (see FIG. 4). The operation of adjusting parameters includes operation on the buttons 23a to 23c, entry into the text box 23d, checking (or unchecking) of the check box 23e, etc. as shown in FIG. 4.

Subsequently, in step 205, the data analyzer 3 (controller 10) executes the script by using the parameters that are adjusted in step 204 on a test basis. As a result, an analysis result of the script after parameter adjustment is displayed in the field 23g on the parameter adjustment screen 23 (see FIG. 4). As shown by an arrow from step 205 to step 204, the parameter adjustment acceptor 7 (controller 10) accepts adjustment of parameters in step 204 even after the script is executed in step 205.

Subsequently, in step 206, the parameters that are adjusted in step 204 and the script corresponding to the adjusted parameters are correlated with each other and saved (registered) in the storage 30. Specifically, the parameters that are adjusted and the script corresponding to the adjusted parameters are correlated with each other and saved (registered) in the storage 30 based on selection of the button 23j on the parameter adjustment screen 23 (see FIG. 4). More specifically, the adjusted parameters, the script whose parameters are adjusted, and the dataset 300 corresponding to the script whose parameters are adjusted are correlated with each other and saved (registered) in the storage 30 by pressing the button 23j if the display changes from the dataset generation screen 22 to the parameter adjustment screen 23. Also, the adjusted parameters, the script whose parameters are adjusted, and the analysis recipe 600 corresponding to the script whose parameters are adjusted are correlated with each other and saved (registered) in the storage 30 if the display changes from the analysis recipe generation screen 24 to the parameter adjustment screen 23.

### Advantages of the Embodiment

In the image analysis apparatus 100 according to this embodiment, the following advantages are obtained.

As discussed above, the image analysis apparatus 100 according to this embodiment includes a controller 10 configured to accept an operation of adjustment of parameters to be used to execute a script, and to analyze data by executing the script based on the adjusted parameters. Accordingly, because parameters in an existing script can be adjusted and the script can be then executed, the script can be executed by using values of the parameters depending on applications, purposes, quality of images to be analyzed, etc. As a result, even when the value(s) of parameter(s) is/are required to be changed, work of creating a new script (program executed by a computer) corresponding to such new parameter(s) can be omitted. A burden on a user in the work of adjusting parameters in such an existing script is smaller than the work of entirely creating a new script from scratch. Consequently, the controller can reduce the burden on a user in the work by accepting an operation of adjustment of a parameter(s) to be used to execute the script (s).

In addition, additional advantages can be obtained by this embodiment added with configurations discussed below.

In this embodiment, as described above, the controller 10 is configured to make the display 20 to display a parameter adjustment screen 23 for adjusting the parameters in accordance with an operation provided by a user, and to accept an operation of adjustment of one or more parameters in the parameters on the parameter adjustment screen 23. Accordingly, the user can adjust the parameters by following items displayed in the parameter adjustment screen 23 on the display 20. Consequently, the user can easily adjust the parameters.

Also, in this embodiment, as described above, the controller 10 is configured to accept an operation of adjustment of a plurality of parameters on the common adjustment screen 23. Accordingly, the user can efficiently adjust the plurality of parameters displayed as compared to a case in which the plurality of parameters are displayed on different adjustment screens 23.

In this embodiment, as described above, the controller 10 is configured to display the data before the script is applied, and test output data that is obtained by applying to the data the script whose parameters are adjusted on a test basis side by side on the parameter adjustment screen 23. Accordingly, the user can adjust the parameters while confirming the test output data obtained by adjusting the parameters the parameter adjustment screen 23. Consequently, it is possible to more efficiently and appropriately adjust the parameters.

In this embodiment, as described above, the controller 10 is configured to accept an operation of selection of the script on the adjustment screen 23. Because both selection of the script and adjustment of the parameter can be accepted on the parameter adjustment screen, a series of operations of script selection and adjustment of the selected parameters can be efficiently made.

In this embodiment, as described above, the controller 10 is configured to selectively display the data before the script is applied, and test output data that is obtained by applying to the data the script whose parameters are adjusted on a test basis on a screen (22, 24) for accepting an operation that is provided by the user to instruct to display the parameter adjustment screen 23 on the display 20. Accordingly, on the screen (22, 24) for accepting an operation that is provided by the user to instruct to display the parameter adjustment screen 23 on the display 20, the user can easily compare the data items before and after the script is applied.

In this embodiment, as described above, the script includes a machine learning generation algorithm for generate machine learning data to be used for machine learning, and an analysis algorithm for analyzing the data.

In addition, the controller 10 is configured to make the display 20 to display, on a dataset generation screen 22 that is displayed on the display 20 when generating a dataset 300 including the machine learning data items, the adjustment screen 23 for adjusting parameters of the machine learning generation algorithm in accordance with the operation provided by the user. In addition, the controller 10 is configured to control the display 20 to display the adjustment screen 23 for the parameters of the analysis algorithm based on the user operation in the analysis recipe generation screen 24 displayed on the display 20 when the analysis recipe 600 is generated by combining a plurality of analysis algorithms. Accordingly, the user can easily display the parameter adjustment screen 23 on the display 20 in operation on the dataset generation screen 22 or the analysis recipe generation screen 24.

In this embodiment, as described above, the controller 10 is configured to make the display 20 to display a registration screen 21 for previously registering the scripts and a parameter definition file that defines parameter adjustment information relating to adjustment of the parameters, and to correlate the scripts and the parameter definition file that are previously registered on the registration screen 21 with each other and store the scripts and the parameter definition file correlated with each other. Accordingly, the user can easily adjust the parameters of the script correlated with the parameter definition file based on the information defined in the parameter definition file.

In this embodiment, as described above, the parameter definition file includes information on initial values of the parameters, adjustable ranges of the parameters, and types of the parameters Accordingly, the user can easily adjust the parameters to desired values based on the initial values of the parameters, the adjustable ranges of the parameters, and the types of the parameters defined in the parameter definition file.

In this embodiment, as described above, the controller 10 is configured to determine whether a format of the parameter definition file is correct when registering the parameter definition file. Accordingly, it is possible to prevent that an incorrectly formatted parameter definition file is used. As a result, it is possible to prevent incorrect analysis caused by such an incorrectly formatted parameter definition file in the image analysis apparatus 100.

In this embodiment, as described above, the data analysis method includes a step of accepting adjustment of parameters to be used to execute the script. Accordingly, because parameters in an existing script can be adjusted and the script can be then executed, the script can be executed by using values of a plurality of parameters depending on applications or purposes. As a result, even when the values of parameters are required to be changed, work of creating a new script corresponding to such new parameters can be omitted. A burden on a user in the work of adjusting parameters in such an existing script is smaller than the work of entirely creating a new script from scratch.

Consequently, it is possible to provide the data analysis method capable of reducing a burden on the user in the work by providing the step of accepting an operation of adjustment of parameters to be used to execute the script.

### Modified Embodiments

Note that the embodiment disclosed this time must be considered as illustrative in all points and not restrictive. The scope of the present invention is not shown by the above description of the embodiments but by the scope of claims for patent, and all modifications (modified embodiments) within the meaning and scope equivalent to the scope of claims for patent are further included.

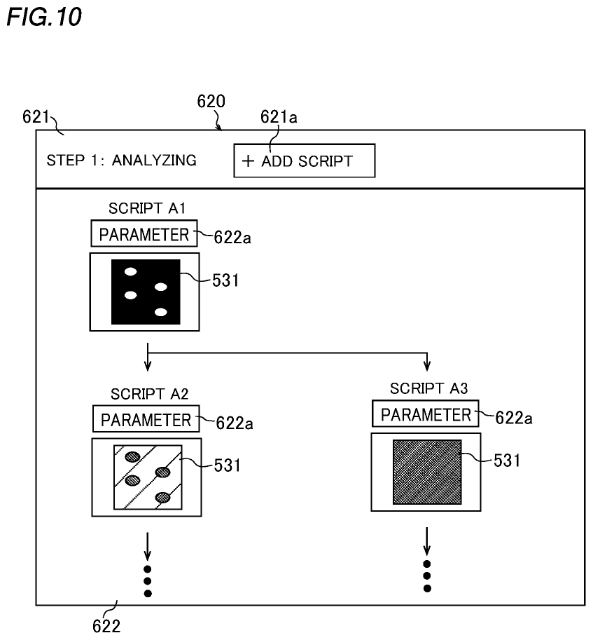

While the example in which only one script is selected in the analysis processing of the analysis recipe 600 has been shown in the aforementioned embodiment, the present invention is not limited to this. A plurality of scripts may be selected in the analysis processing. Specifically, as shown in FIG. 10, in the analysis processing, a script A1, a script A2, and a script A3 are selected. The script A1 and the script A2 or the script A3 is combined in series with each other. The script A2 and the script A3 are combined in parallel with each other. In this case, buttons 622a indicating “Parameter” corresponding to the script A1, the script A2, and the script A3 are displayed on the analysis recipe generation screen 24. That is, the parameters of the script A1, the script A2, and the script A3 can be individually adjusted by pressing the button 622a corresponding to the script A1, the script A2, and the script A3.

While the example in which a plurality of parameters can be adjusted on the parameter adjustment screen 23 has been shown in the aforementioned embodiment, the present invention is not limited to this. Only one parameter may be allowed to be adjusted on the parameter adjustment screen 23.

While the example in which the parameter of the script B (analysis algorithm) (see FIG. 7) executed in the finishing processing is not adjusted has been shown in the aforementioned embodiment, the present invention is not limited to this. The parameter may be allowed to be adjusted also in the script B executed in the finishing processing.

While the example in which it is possible to switch between data before the script is applied and data after the script corresponding to the adjusted parameters only on the dataset generation screen 22 has been shown in the aforementioned embodiment, the present invention is not limited to this. The switching between data before the script is applied and data after the script corresponding to the adjusted parameters only on the dataset generation screen may be allowed also one the analysis recipe generation screen 24 (analysis flow generation screen).

While the example in which the data analysis apparatus is the image analysis apparatus 100 for analyzing image data has been shown in the aforementioned embodiment, the present invention is not limited to this. The data analysis apparatus may be an analysis apparatus that analyzes data to be analyzed (e.g., gas chromatography analysis data) other than image data.

While the example in which the display changes from the dataset generation screen 22 and the analysis recipe generation screen 24 to the parameter adjustment screen 23 has been shown in the aforementioned embodiment, the present invention is not limited to this. The display may change from a screen other than the dataset generation screen 22 and the analysis recipe generation screen 24 to the parameter adjustment screen 23. In other words, the parameters may be allowed to be adjusted in processing other than the generation of the dataset 300 and the analysis recipe 600.

### (Mode Item 1)

A data analysis apparatus includes a controller configured to accept an operation of selection of an analysis data item(s) acquired by an analyzer, to accept an operation of selection of a script(s) to be used to analyze data based on the analysis data item(s), to accept an operation of adjustment of a parameter(s) to be used to execute the script(s), and to analyze the data by executing the script(s) based on the adjusted parameter(s); and a display configured to display an analysis result obtained by the analysis of the data by the controller.

### (Mode Item 2)

In the data analysis apparatus according to mode item 1, the controller is configured to make the display to display a parameter adjustment screen for adjusting the parameter(s) in accordance with an operation provided by a user, and to accept an operation of adjustment of one or more parameters in the parameters on the parameter adjustment screen.

### (Mode Item 3)

In the data analysis apparatus according to mode item 2, the controller is configured to accept an operation(s) of adjustment of a plurality of parameters on a common adjustment screen as the adjustment screen.

### (Mode Item 4)

In the data analysis apparatus according to mode item 2 or 3, the controller is configured to display the data before the script is applied, and test output data that is obtained by applying to the data the script whose parameter(s) is/are adjusted on a test basis side by side on the parameter adjustment screen.

### (Mode Item 5)

In the data analysis apparatus according to any of mode items 2 to 4, the controller is configured to accept the operation(s) of selection of the script(s) on the adjustment screen.

### (Mode Item 6)

In the data analysis apparatus according to any of mode items 2 to 5, the controller is configured to selectively display the data before the script is applied, and output data that is obtained by applying to the data the script whose parameter(s) is/are adjusted on a screen for accepting an operation that is provided by the user to instruct to display the parameter adjustment screen on the display.

### (Mode Item 7)

In the data analysis apparatus according to any of mode items 2 to 6, each script includes a machine learning generation algorithm for generate machine learning data items to be used for machine learning, and an analysis algorithm for analyzing the data; and the controller is configured to make the display to display, on a dataset generation screen that is displayed on the display when generating a dataset including the machine learning data items, the adjustment screen for adjusting a parameter(s) of the machine learning generation algorithm in accordance with the operation provided by the user, and to make the display to display, on an analysis flow generation screen that is displayed when generating an analysis flow that includes a plurality of analysis algorithms combined with each other, the adjustment screen for adjusting a parameter(s) of the analysis algorithms in accordance with the operation provided by the user.

### (Mode Item 8)

In the data analysis apparatus according to any of mode items 1 to 7, the controller is configured to make the display to display a registration screen for previously registering the script(s) and a parameter definition file that defines parameter adjustment information relating to adjustment of the parameter(s), and to correlate the script(s) and the parameter definition file that are previously registered on the registration screen with each other and store the script(s) and the parameter definition file correlated with each other.

### (Mode Item 9)

In the data analysis apparatus according to mode item 8, the parameter definition file includes information on initial value(s) of the parameter(s), an adjustable range(s) of the parameter(s), and a type(s) of the parameter(s).

### (Mode Item 10)

In the data analysis apparatus according to mode item 8 or 9, the controller is configured to determine whether a format of the parameter definition file is correct when registering the parameter definition file.

### (Mode Item 11)

A data analysis method includes a step of accepting selection of an analysis data item(s) acquired by an analyzer; a step of accepting selection of a script(s) to be used to analyze data based on the analysis data item(s); a step of accepting adjustment of a parameter(s) to be used to execute the script(s); and a step of analyzing the data by executing the script(s) based on the adjusted parameter(s).

### DESCRIPTION OF REFERENCE NUMERALS

10; controller
20; display
21; registration screen
22; dataset generation screen (screen for accepting operation provided by user to instruct to display parameter adjustment screen on display)
24; analysis recipe generation screen (analysis flow generation screen) (screen for accepting operation provided by user to instruct to display parameter adjustment screen on display)
23; parameter adjustment screen
100; image analysis apparatus (data analysis apparatus)
200; image acquirer (analyzer)
300; dataset
500; phase contrast images (analysis data) (data based on analysis data) (data before script is applied)
501; contrast adjustment image (data based on analysis data) (analysis result) (test output data) (machine learning data)
510, 520; fluorescence image (analysis data) (data based on analysis data) (data before script is applied)
511, 521; binary image (data based on analysis data) (analysis results) (test output data) (machine learning data)
530; image data (analysis data) (data based on analysis data) (data before script is applied)
531; data (data based on analysis data) (analysis result) (test output data)
600; analysis recipe (analysis flow)

1. A data analysis apparatus comprising:
a controller configured to accept an operation of selection of an analysis data item(s) acquired by an analyzer, to accept an operation of selection of a script(s) to be used to analyze data based on the analysis data item(s), to accept an operation of adjustment of a parameter(s) to be used to execute the script(s), and to analyze the data by executing the script(s) based on the adjusted parameter(s); and
a display configured to display an analysis result obtained by the analysis of the data by the controller.

2. The data analysis apparatus according to claim 1, wherein the controller is configured to make the display to display a parameter adjustment screen for adjusting the parameter(s) in accordance with an operation provided by a user, and to accept an operation of adjustment of one or more parameters in the parameters on the parameter adjustment screen.

3. The data analysis apparatus according to claim 2, wherein the controller is configured to accept an operation(s) of adjustment of a plurality of parameters on a common adjustment screen as the adjustment screen.

4. The data analysis apparatus according to claim 2, wherein the controller is configured to display the data before the script is applied, and test output data that is obtained by applying to the data the script whose parameter(s) is/are adjusted on a test basis side by side on the parameter adjustment screen.

5. The data analysis apparatus according to claim 2, wherein the controller is configured to accept the operation(s) of selection of the script(s) on the adjustment screen.

6. The data analysis apparatus according to claim 2, wherein the controller is configured to selectively display the data before the script is applied, and test output data that is obtained by applying to the data the script whose parameter(s) is/are adjusted on a test basis on a screen for accepting an operation that is provided by the user to instruct to display the parameter adjustment screen on the display.

7. The data analysis apparatus according to claim 2, wherein
each script includes a machine learning generation algorithm for generate machine learning data items to be used for machine learning, and an analysis algorithm for analyzing the data; and
the controller is configured to make the display to display, on a dataset generation screen that is displayed on the display when generating a dataset including the machine learning data items, the adjustment screen for adjusting a parameter(s) of the machine learning generation algorithm in accordance with the operation provided by the user, and to make the display to display, on an analysis flow generation screen that is displayed when generating an analysis flow that includes a plurality of analysis algorithms combined with each other, the adjustment screen for adjusting a parameter(s) of the analysis algorithms in accordance with the operation provided by the user.

8. The data analysis apparatus according to claim 1, wherein the controller is configured to make the display to display a registration screen for previously registering the script(s) and a parameter definition file that defines parameter adjustment information relating to adjustment of the parameter(s), and to correlate the script(s) and the parameter definition file that are previously registered on the registration screen with each other and store the script(s) and the parameter definition file correlated with each other.

9. The data analysis apparatus according to claim 8, wherein the parameter definition file includes information on initial value(s) of the parameter(s), an adjustable range(s) of the parameter(s), and a type(s) of the parameter(s).

10. The data analysis apparatus according to claim 8, wherein the controller is configured to determine whether a format of the parameter definition file is correct when registering the parameter definition file.

11. A data analysis method comprising:
a step of accepting selection of an analysis data item(s) acquired by an analyzer;
a step of accepting selection of a script(s) to be used to analyze data based on the analysis data item(s);
a step of accepting adjustment of a parameter(s) to be used to execute the script(s); and
a step of analyzing the data by executing the script(s) based on the adjusted parameter(s).
